(19) United States
(12) Patent Application Publication
(10) Pub. No.: US 2010/0151850 A1
(43) Pub. Date: Jun. 17, 2010

(54) System and Method for Adapting Mobile Applications

(75) Inventors: Milap Majmundar, Austin, TX (US); David R. Wolter, Austin, TX (US); Mostafa Tofigh, Cupertino, CA (US)

Correspondence Address: AT&T Legal Department - LNA;Attn: Patent Docketing, Room 2A- 207, One AT & T Way, Bedminster, NJ, 07921, US

(73) Assignee: AT&T CORP., New York, NY (US)

(21) Appl. No.: 12/335,292

(22) Filed: Dec. 15, 2008

(51) Int. Cl. H04W 24/00; H04M 1/00

(52) U.S. Cl. 455/423; 455/550.1

(57) ABSTRACT

A method for modifying an application of a wireless device based on triggers received at the wireless device includes analyzing a network trigger and at least one other trigger associated with a wireless device, and adjusting a device-level component parameter of the wireless device based on one of the triggers. The method also synchronizes an application parameter of the wireless device with the device-level component parameter; and synchronizes the application parameter with network. A device for performing the method is also disclosed.

### FIELD OF THE DISCLOSURE

The present disclosure generally relates to communications networks, and more particularly relates to a system and method for adapting mobile device applications based on specific needs.

### BACKGROUND

A software application is typically developed to be run on a specific device, and as such the application can be adapted to certain platform characteristics of the device. The different platform characteristics can include screen size, memory, communication bandwidth, and the like. The different platform characteristics can cause the user experience for the same application to differ across device platforms. Additionally, operation of different applications on a wireless device can vary depending on a location of the wireless device and the type and strength of the wireless network to which the wireless device is connected.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a wireless device;

FIG. 2 is a flow diagram of a method for adapting an application of a wireless device based on triggers received at the wireless device;

FIG. 3 is a flow diagram of an alternative method for adapting an application of a wireless device based on triggers received at the wireless device;

FIG. 4 is a flow diagram of another alternative method for adapting an application of a wireless device based on triggers received at the wireless device;

FIG. 5 is a flow diagram of a method for adapting a device-level component of a wireless device based on a trigger received at the wireless device; and

FIG. 6 is a block diagram of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

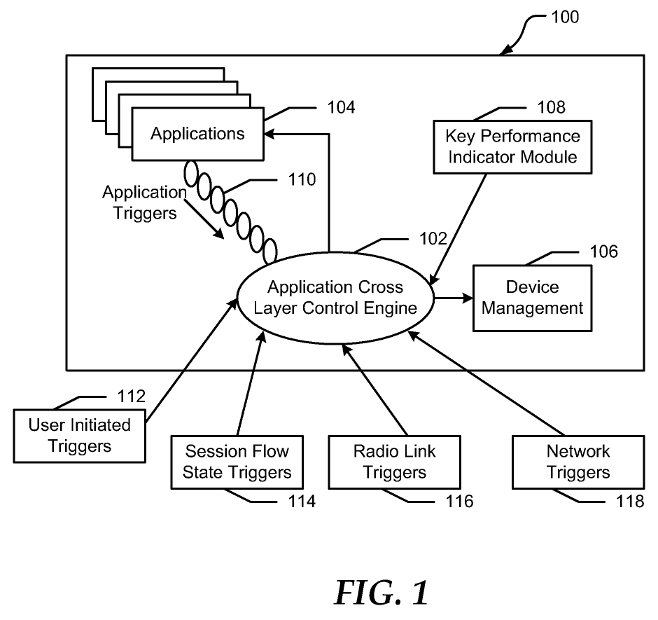

FIG. 1 shows a block diagram of a wireless device 100 including an application cross layer control engine 102, a plurality of applications 104, a device management module 106, and a key performance indicator (KPI) module 108. The application cross layer control engine 102 is in communication with the applications 104, with the device management module 106, and with the KPI module 108. The application cross layer control engine 102 can receive and analyze different triggers from various sources. The triggers can be changes in an available bandwidth over a network accessed by the wireless device 100, user initiated changes of the applications 104 on the wireless device, and the like. The triggers can include application triggers 110, user initiated triggers 112, session flow state triggers 114, radio link triggers 116, network triggers 118, triggers from the KPI module 108, and the like.

The application triggers 110 can cause the application cross control engine 102 to dynamically adapt the applications 104 according to the needs of the user, and/or according to a type of wireless device 100 that is executing the application 104. For example, depending on whether the wireless device 100 is a mobile computer, a cellular telephone, or the like, one of the application triggers 110 can indicate that an output format for the application 104 needs to be changed. In response, the application cross layer control engine 102 can adapt the output format for the application. The output format can vary the size of graphics, the size of text, and the like associated with the application 104. Thus, graphics and text associated with the application 104 can be smaller when displayed on a cellular telephone with a relatively smaller screen than when displayed on a mobile computer with a relatively larger screen. Additionally, one of the application triggers 110 can verify that the application can operate properly based on changes to be made by the application cross layer control engine 102 in response to the other triggers discussed below. Thus, before the application cross layer control engine 102 makes a change to an application or the device in response to a received trigger, the application cross layer control engine can wait for the application trigger 110 to verify that the change can be made.

The user initiated triggers 112 can request a network change from one radio access technology to another. These radio access technologies can include Global System for Mobile communications (GSM), Worldwide Interoperability for Microwave Access (WiMAX), Wireless Fidelity (Wi-Fi), third generation (3G) networks, code division multiple access (CDMA) networks, time division multiple access (TDMA) networks, Long Term Evolution (LTE), and the like. For example, one of the user-initiated triggers 112 can indicate that the user has selected an option to change from a GSM network connection to a Wi-Fi network connection. In response, the application cross layer control engine 102 can end the GSM network connection and can connect with the available Wi-Fi network. Upon receiving and analyzing the user initiated trigger 112, the application cross layer control engine 102 can send a control signal to the device management module 106 to adapt the network connection from one radio access technology to another.

The session flow state triggers 114 can indicate whether the user is in an active session, at a particular location, and the like. An active session can be that the wireless device 100 is currently connected to the network and actively transferring data over the network. Based on the session flow state triggers 114, the application cross layer control engine 102 can disable/enable different applications 104. For example, if the wireless device 100 is not connected to the network, the session flow state trigger 114 indicates that the wireless device is not in an active session. In response, the application cross layer control engine 102 can disable an application 104 that receives periodic updates from the network.

The radio link triggers 116 can indicate any changes in the underlying radio link, such as a change in a communication bandwidth, delay characteristics, reliability, etc. of the radio link. The radio link can be a wireless connection between wireless device 100 and a communication tower of the wireless network. Based on the application cross layer control engine 102 analyzing the radio link trigger 116 and determining that the available bandwidth has changed, the application cross layer control engine can adapt the applications 104 that use the radio link.

For example, one of the applications 104 can be designed to synchronize with a server at regular intervals, and every time the application synchronizes, a large amount of the communication bandwidth is used. Thus, the radio link trigger 116 indicates that the communication bandwidth is less than a specific amount, and in response the application cross layer control engine 102 can adapt the application 104 to synchronize with the network less often. Thus, the limited amount bandwidth available will not be used for the synchronization of the application 104.

The network triggers 118 from other layers in the protocol stack can indicate that an adaptation of a transport protocol parameter is required. Transport protocol parameters can be the different methods used by the wireless device 100 to packetize or group data to be transferred within the wireless device 100 and/or over the wireless network. For example, based on a network trigger 118 indicating that there is an increased amount of traffic over the network, the application cross layer control engine 102 can adjust a transport protocol parameter for the applications 104. The transport protocol parameter adjusted can be a transport control protocol (TCP) packet size.

For example, the TCP packet size can be reduced to allow data to be transferred more efficiently between the wireless device 100 and the wireless network during periods of high traffic on the wireless network. An additional network trigger 118 can indicate that an end device cannot receive the data transferred from the wireless device 100 as quickly as the wireless device is sending the data. In response, the application cross layer control engine 102 can adapt the transfer rate for the wireless device 100, so that the end device can receive the data at the same rate that the wireless device 100 is transmitting the data. Therefore, in response to these different types of triggers discussed above, the application cross layer control engine 102 can influence and/or adapt several components that affect the performance of an application 104.

The KPI module 108 can store certain performance thresholds for the applications 104 and the wireless device 100. The performance thresholds can include a quality of video or audio received by the user, a delay between a user action and a corresponding network response, and the like. If the KPI module 108 determines that the performance experienced by the user is below one of the performance thresholds, the KPI module can send a trigger to the application cross layer control engine 102. In response, the application cross layer control engine 102 can adjust an application parameter similarly as discussed above or device-level parameter as discussed below.

For example, one of the performance thresholds can be that the user wants a response by the network within a certain delay with performing certain actions on an online gaming application. If the KPI module 108 determines that the delay between the user action and the corresponding network response is below the performance threshold, the KPI module can send a trigger to the application cross layer control engine 102. In response, the application cross layer control engine 102 can initiate the device management module 106 to change to a different radio access technology which can provide a better delay response for the online gaming application.

The application cross layer control engine 102 can allow the applications 104 to be designed for a consistent user experience across a wide range of devices. For example, large wireless service providers can develop their own branded services and can provide users with a seamless user experience over a number of different devices used by the user. In different embodiments, there can be multiple application cross layer control engines 102 to receive the triggers and to control the applications 104 and the device management module 106. It should be understood that the application cross layer control engine 102 and the device management module 106 can be implemented in hardware, software, and/or any combination of hardware and software.

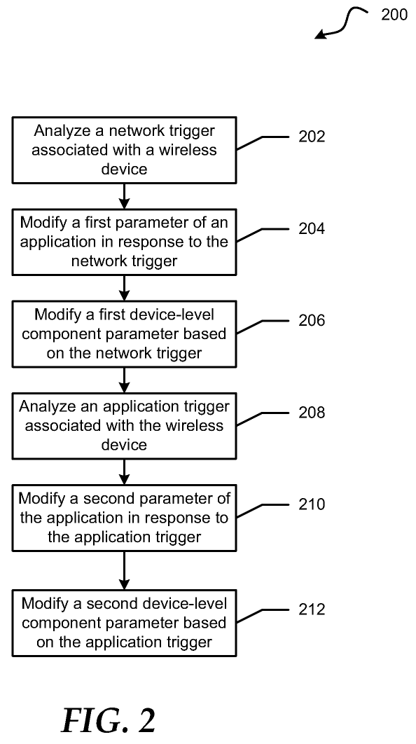

FIG. 2 shows a flow diagram of a method 200 for adapting an application of a wireless device based on triggers received at the wireless device. At block 202, a network trigger associated with the wireless device is analyzed. The network trigger can indicate that a change in a radio access technology is needed. A first parameter of an application of the wireless device is modified in response to the network trigger at block 204. The first parameter of the application can be to enable the application, to disable the application, to adjust the synchronization of the application, to change the application output format, and the like.

At block 206, a first device-level component parameter is modified based on the network trigger. The device-level component parameter can be a radio access technology parameter, a transport protocol parameter, a data transfer rate parameter, and the like. The device-level component parameter can also be a parameter that affects how the entire device operates and not only one particular application. Thus, the device-level parameter can affect all of the applications that run on the device. An application trigger associated with the wireless device is analyzed at block 208. The application trigger can indicate that a change in an output format of the application is needed, a different compression level is required, and the like. At block 210, a second parameter of the application is modified in response to the application trigger. The second parameter of the application can be to enable the application, to disable the application, to adjust the synchronization of the application, to change the application output format, to change compression level, and the like. A second device-level component parameter is modified based on the application trigger at block 212.

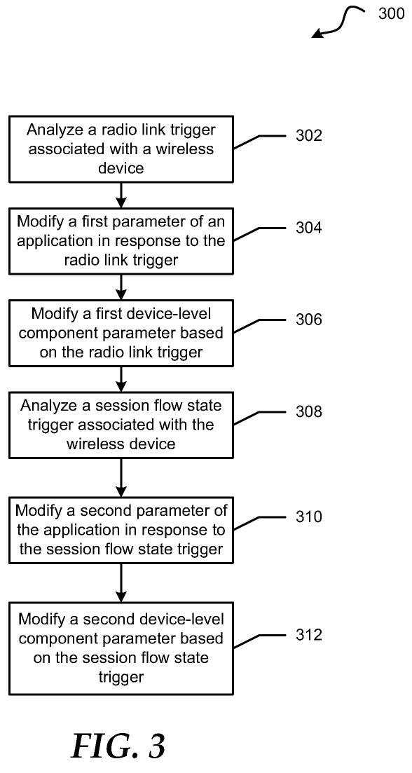

FIG. 3 shows a flow diagram of an alternative method 300 for adapting an application of a wireless device based on triggers received at the wireless device. At block 302, a radio link trigger associated with the wireless device is analyzed. The radio link trigger can indicate that a communication bandwidth has decreased, packet delay or loss has increased, and the like. A first parameter of an application of the wireless device is modified in response to the radio link trigger at block 304. The first parameter of the application can be to enable the application, to disable the application, to adjust the synchronization of the application, to change the application output format, and the like.

At block 306, a first device-level component parameter is modified based on the radio link trigger. The device-level component parameter can be a radio access technology parameter, a transport protocol parameter, a data transfer rate parameter, and the like. A session flow state trigger associated with the wireless device is analyzed at block 308. The session flow state trigger can indicate that the wireless device is in an active session. At block 310, a second parameter of the application is modified in response to the session flow state trigger. The second parameter of the application can be to enable the application, to disable the application, to adjust the synchronization of the application, to change the application output format, and the like. A second device-level component parameter is modified based on the session flow state trigger at block 312.

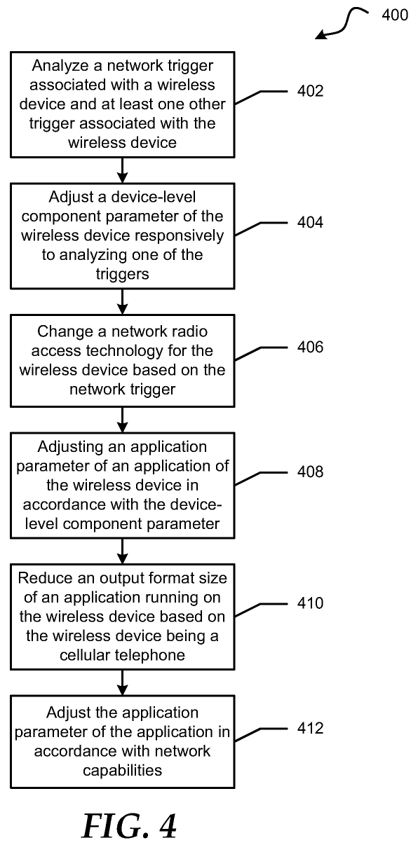

FIG. 4 shows a flow diagram of an alternative method 400 for adapting an application of a wireless device based on triggers received at the wireless device. At block 402, a network trigger associated with the wireless device and at least one other trigger associate with the wireless device is analyzed. The different sources can include a radio link, a network, a user behavior, a network policy input, an application trigger, a session state, a KPI module, and the like. Responsively to analyzing one of the triggers, a device-level component parameter of the wireless device is automatically adjusted at block 404. The device-level component parameter can be a radio access technology parameter, a transport protocol parameter, a data transfer rate parameter, and the like.

At block 406, a network radio access technology for the wireless device is changed based on the one of the triggers being the network trigger. An application parameter of an application of the wireless device is adjusted in accordance with the adjusted device-level component parameter at block 408. The application parameter can be to enable the application, to disable the application, to adjust the synchronization of the application, to change the application output format, and the like. At block 410, an output format size of an application running on the wireless device is reduced based on the wireless device being a cellular telephone. The application parameter is adjusted in accordance with network capabilities at block 412.

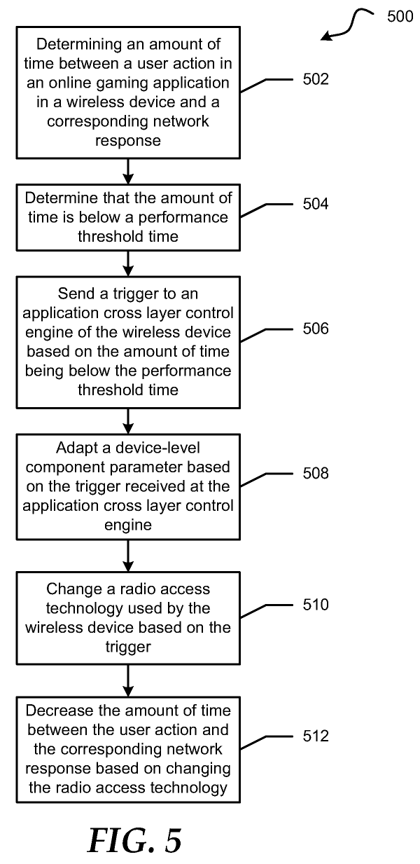

FIG. 5 shows a flow diagram of a method 500 for adapting a device-level component of a wireless device based on a trigger received at the wireless device. At block 502, an amount of time between a user action in an online gaming application in a wireless device and a corresponding network response is determined. It is determined that the amount of time is below a performance threshold time at block 504. At block 506, a trigger is sent to an application cross layer control engine of the wireless device based on the amount of time being below the performance threshold time. A device-level component parameter is adapted based on the trigger received at the application cross layer control engine at block 508. At block 510, a radio access technology used by the wireless device is changed based on the trigger. The radio access technology can be the device-level component parameter. The amount of time between the user action and the corresponding network response is decrease based on changing the radio access technology at block 512. The decrease in the amount of time can improve the user experience for the online gaming application.

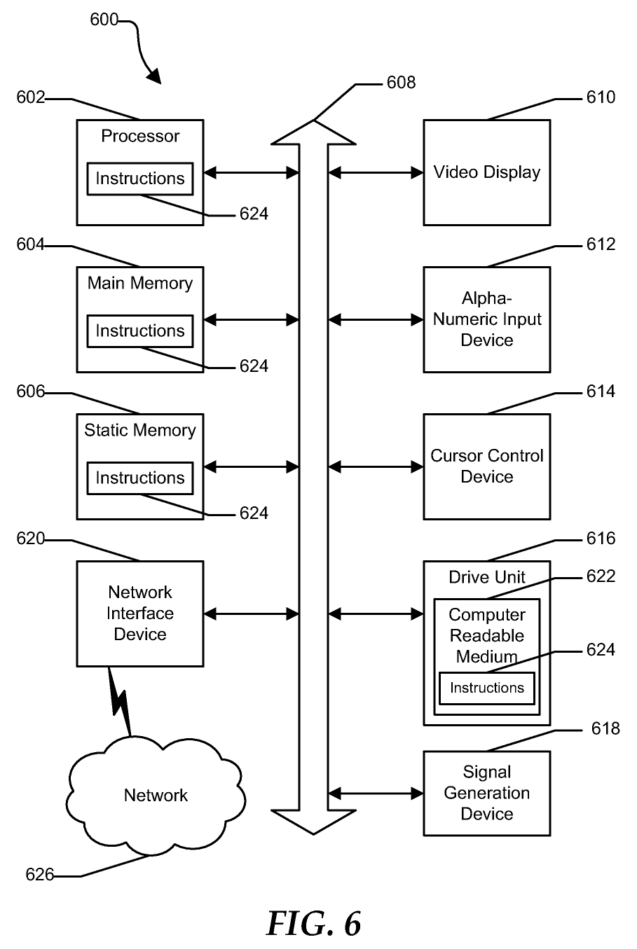

FIG. 6 shows an illustrative embodiment of a general computer system 600 in accordance with at least one embodiment of the present disclosure. The computer system 600 can include a set of instructions that can be executed to cause the computer system to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

The computer system 600 may include a processor 602, e.g., a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media. The network interface device 620 can provide connectivity to a network 626, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method comprising:
analyzing a network trigger associated with a wireless device and at least one other trigger associated with the wireless device;
responsively to analyzing one of the triggers, automatically adjusting a device-level component parameter of the wireless device;
adjusting an application parameter of an application of the wireless device in accordance with the adjusted device-level component parameter; and
adjusting the application parameter of the application in accordance with network capabilities.

2. The method of claim 1 wherein the other trigger includes a radio link, a user behavior, a network policy input, an application, a session state, and a key performance indicator module.

3. The method of claim 1 wherein the application parameter is selected from the group consisting of enable application, disable application, application synchronization, and application output format.

4. The method of claim 1 wherein the device-level component parameter is selected from the group consisting of a radio access technology parameter, a transport protocol parameter, and a data transfer rate parameter.

5. The method of claim 1 wherein adjusting the device-level component parameter further comprises:
changing a network radio access technology for the wireless device based on the one of the triggers being a performance indicator trigger.

6. The method of claim 1 wherein adjusting the device-level component parameter further comprises:
changing a network radio access technology for the wireless device based on the network trigger.

7. The method of claim 1 wherein synchronizing the application parameter with the device-level component parameter further comprises:
reducing an output format size of an application running on the wireless device based on the wireless device being a cellular telephone.

8. A method comprising:
analyzing a radio link trigger received at a wireless device;
adapting a first parameter of a first application of the wireless device in response to the radio link trigger;
analyzing a session flow state trigger received at the wireless device; and
adapting a second parameter of a second application of the wireless device in response to the session flow state trigger.

9. The method of claim 8 further comprising:
adapting a device-level component parameter based on the radio link trigger.

10. The method of claim 9 wherein the device-level component parameter is selected from the group consisting of a radio access technology parameter, a transport protocol parameter, and a data transfer rate parameter.

11. The method of claim 8 wherein adapting the first parameter of the first application in response to the radio link trigger further comprises:
changing an amount of synchronization performed by the first application over a network based on the radio link trigger.

12. The method of claim 8 wherein the first parameter and the second parameter are selected from the group consisting of enable application, disable application, application synchronization, and application output format.

13. The method of claim 8 further comprising:
adapting a device-level component parameter based on the session flow state trigger.

14. The method of claim 8 wherein adapting the second parameter of the second application in response to the session flow state trigger further comprises:
disabling the second application based on the session flow state trigger.

15. A method comprising:
analyzing a network trigger received at a wireless device;
adapting a first parameter of a first application of the wireless device in response to the network trigger;
analyzing a user initiated trigger received at the wireless device; and
adapting a second parameter of a second application of the wireless device in response to a user initiated trigger.

16. The method of claim 15 further comprising:
adapting a device-level component parameter based on the network trigger.

17. The method of claim 16 wherein the device-level component parameter is selected from the group consisting of a radio access technology parameter, a transport protocol parameter, and a data transfer rate parameter.

18. The method of claim 16 wherein adapting the device-level component parameter further comprises:
changing a transport control protocol parameter based on the network trigger.

19. The method of claim 15 wherein the first parameter and the second parameter are selected from the group consisting of enable application, disable application, application synchronization, and application output format.

20. The method of claim 15 further comprising:
adapting a device-level component parameter based on the user initiated trigger.

21. The method of claim 15 wherein adapting the device-level component parameter further comprises:
changing a radio access technology used by the wireless device based on the user initiated trigger.

22. A wireless device comprising:
a key performance indicator module configured to output a first trigger in response to a user experience being below a performance threshold;
an application cross layer control engine configured to initiate a change in an application parameter and a device-level component parameter based on the first trigger from the key performance indicator module and based on a second trigger from a different source; and
a device management module configured to adjust the device-level component in response to receiving an adjust signal from the application cross layer control engine.

23. The wireless device of claim 22 wherein the different source is selected from a group consisting of a radio link, a network, a user behavior, a network policy input, an application, and a session state.

24. The wireless device of claim 22 wherein the application parameter is selected from the group consisting of enable application, disable application, application synchronization, and application output format.

25. The wireless device of claim 22 wherein the device-level component parameter is selected from the group consisting of a radio access technology parameter, a transport protocol parameter, and a data transfer rate parameter.

26. A method comprising:
determining an amount of time between a user action in an online gaming application in a wireless device and a corresponding network response;
determining that the amount of time is below a performance threshold time;
sending a trigger to an application cross layer control engine of the wireless device based on the amount of time being below the performance threshold time; and
adapting a device-level component parameter based on the trigger received at the application cross layer control engine.

27. The method of claim 15 wherein adapting a device-level component parameter further comprises:
changing a radio access technology used by the wireless device based on the trigger.

28. The method of claim 16 further comprising:
decreasing the amount of time between the user action and the corresponding network response based on changing the radio access technology.

29. The method of claim 15 wherein the wireless device is selected from the group consisting of a cellular telephone, a multimedia device.
